(19) United States
(12) Patent Application Publication
(10) Pub. No.: US 2015/0121762 A1
(43) Pub. Date: May 7, 2015

(54) PULL CORD FIXING SUPPORT FOR INNER AND OUTER WINDOWS

(71) Applicant: Tser Wen CHOU, Taipei City (TW)

(72) Inventor: Tser Wen CHOU, Taipei City (TW)

(21) Appl. No.: 14/072,455

(22) Filed: Nov. 5, 2013

(51) Int. Cl. E05F 11/06; E05F 11/04

(52) U.S. Cl. CPC E05F 11/06; E05F 11/04
USPC 49/352

(57) ABSTRACT

A pull cord fixing support for inner and outer windows includes a main support body, a movable support, a roller and a fixing toothed section, which are assembled with each other. The pull cord fixing support serves to fix a bead pull cord on a wall. The bead pull cord is first connected and engaged with the roller mounted on the movable support by means of the fixing toothed section. Then a fixing screw is used to affix the main support body on the wall. At the same time, the fixing toothed section is pulled downward to disengage the fixing toothed section from the roller. Under such circumstance, the bead pull cord can be operated. The roller is freely rotatable along with the movable support. Therefore, the pull cord can be universally operated. The pull cord fixing support is applicable to both inner window and outer window.

### BACKGROUND OF THE INVENTION

1. Field of the Invention

The present invention relates generally to a pull cord fixing support for inner and outer windows, and more particularly to a pull cord fixing support, which can be installed without directional limitation and is applicable to both inner window and outer window.

2. Description of the Related Art

The bead pull cord is an important component for controlling a roller curtain or a blind to move upward and downward. The conventional bead pull cord is generally naturally suspended from the wall face of an inner window or an outer window. Under such circumstance, a child is very likely to play the bead pull cord and tangle the bead pull cord with his/her own neck. This is extremely dangerous. To solve this problem, a pull cord fixing device has been developed for affixing the pull cord on the wall face of an inner window or an outer window to prevent a child from playing the bead pull cord. However, the roller of the conventional bead pull cord fixing device for the pull cord to wind thereon has a fixed angle and different users operate the bead pull cord in different angles. Accordingly, it is hard to align the bead pull cord with the fixing device and conduct the bead pull cord through the fixing device. It often takes place that the bead pull cord tangles with the fixing device. Therefore, the current pull cord fixing device is not optimal in operation and needs to be improved.

### SUMMARY OF THE INVENTION

It is therefore a primary object of the present invention to provide a pull cord fixing support. The roller of the pull cord fixing support is mounted on a 360-degree rotatable movable support so that the roller is universally rotatable in accordance with the suspending angle of the bead pull cord. Accordingly, the bead pull cord can be easily passed through and wound on the roller to solve the problem of the conventional pull cord fixing device that the bead pull cord is hard to operate. Moreover, when using a fixing screw to affix the main support body onto a wall face, the bead pull cord is released at the same time. Therefore, the operation of the pull cord is facilitated.

To achieve the above and other objects, the pull cord fixing support for inner and outer windows of the present invention includes a main support body, a movable support, a roller and a fixing toothed section, which are assembled with each other. The main support body is composed of a first casing and a second casing, which are mated and assembled with each other. The first casing is formed with a slot with a large-diameter end and a small-diameter end in communication with each other. The second casing is formed with a hole in alignment with the large-diameter end of the slot, whereby a fixing screw can be passed through the hole. An upper end of inner face of the second casing is formed with a receiving cavity. A lower end of the inner face of the second casing is formed with a slide channel. The movable support has two lugs at upper end for mounting the roller between the two lugs by means of a locating screw. A bottom end of the movable support has a cylindrical body, which is 360-degree rotatably received in the receiving cavity of the second casing. The fixing toothed section has a toothed seat and multiple fixing teeth disposed at upper end of the toothed seat. The fixing toothed section further has a slide board extending from a lower end of the fixing toothed section. The slide board is up and down slidably disposed in the slide channel of the second casing. A lower end of the slide board is formed with a perforation. A fixing screw can be passed through the perforation to drive the slide board to up and down slide within the slide channel. An elastic member is received in the toothed seat to provide elastic force to make the fixing teeth of the fixing toothed section upward abut against a lower side of the roller.

The present invention can be best understood through the following description and accompanying drawings, wherein:

### BRIEF DESCRIPTION OF THE DRAWINGS

FIG. 1 is a front perspective assembled view of the present invention;

FIG. 2 is a rear perspective assembled view of the present invention;

FIG. 3 is a sectional assembled view of the present invention;

FIG. 4 is a perspective exploded view of the present invention, showing the installation of the pull cord;

FIG. 5 is a perspective view showing the installation of the present invention;

FIG. 6 is a sectional view showing the operation of the present invention;

FIG. 7 is a view showing that the present invention is affixed to a wall face;

FIG. 8 is a perspective view showing that the movable support of the present invention is rotated;

FIG. 9 is a perspective view of the present invention, showing that a pad block is additionally disposed at the rear end of the main support body; and

FIG. 10 is a view showing that present invention is affixed to a wall face of an outer window.

### DETAILED DESCRIPTION OF THE PREFERRED EMBODIMENTS

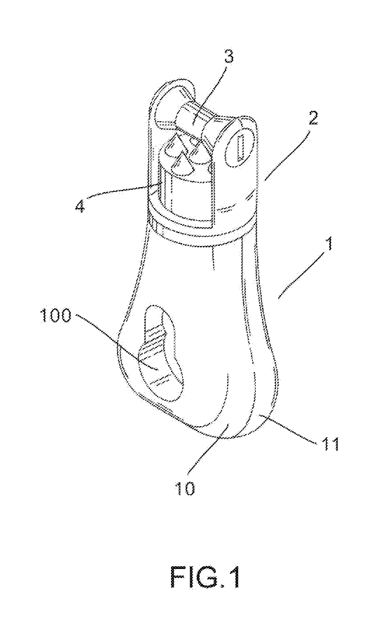

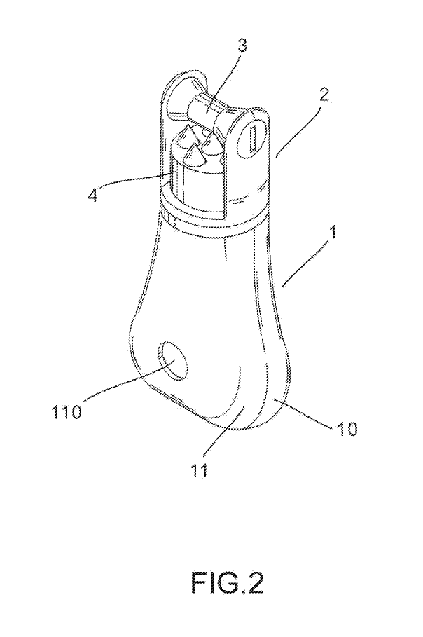

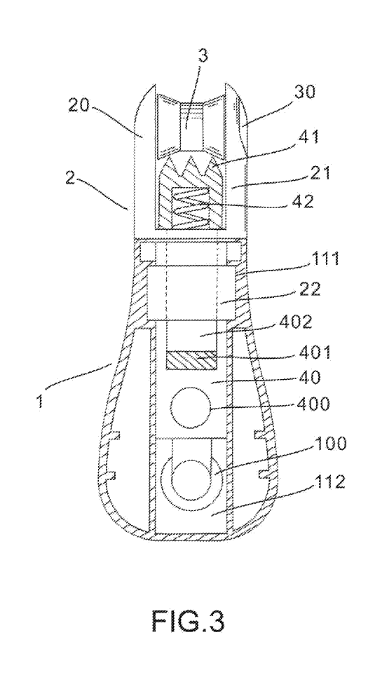

Please refer to FIGS. 1, 2 and 3. The pull cord fixing support for inner and outer windows of the present invention includes a main support body 1, a movable support 2, a roller 3 and a fixing toothed section 4, which are assembled with each other. The main support body 1 is composed of a first casing 10 and a second casing 11, which are assembled with each other. The front face of the first casing 10 is formed with a slot 100 with a large-diameter lower end and a small-diameter upper end in communication with the lower end. The front face of the second casing 11 is formed with a circular hole 110 in alignment with the large-diameter lower end of the slot 100 (as shown in FIG. 2). A top section of inner face of the second casing 11 has an internal receiving cavity 111 (as shown in FIG. 3). A bottom end of the movable support 2 has a cylindrical body 22, which is rotatably positioned in the receiving cavity 111. A bottom section of the inner face of the second casing 11 is formed with a slide channel 112. The fixing toothed section 4 has a slide board 40 extending from a lower end of the fixing toothed section 4. The slide board 40 is up and down slidably received in the slide channel 112. A middle section of the slide board 40 is formed with a notch 402 for a stopper board 401 to restrict the moving distance of the slide board 40. In addition, a lower end of the slide board 40 is formed with a perforation 400. A fixing screw can be passed through the perforation 400 to drive the slide board 40 to move up and down. Multiple fixing teeth 41 are disposed at an upper end of a base seat of the fixing toothed section 4. An elastic member 42 is received in the base seat to provide elastic force to make the fixing teeth 41 upward abut against a lower side of the roller 3. A locating screw 30 is passed through the roller 3 to locate the roller 3 between two lugs 20, 21 upward extending from the movable support 2. The cylindrical body 22 integrally extends from the bottom end of the movable support 2. The cylindrical body 22 is rotatably received in the receiving cavity 11, whereby the roller 3 can be 360-degree rotated along with the cylindrical body 22. The above components are assembled with each other to form the fixing support of the present invention (as shown in FIGS. 1, 2 and 3).

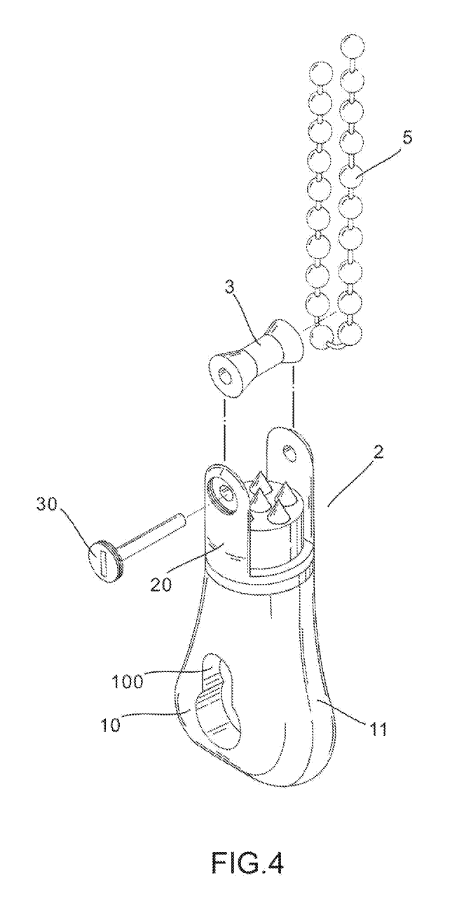

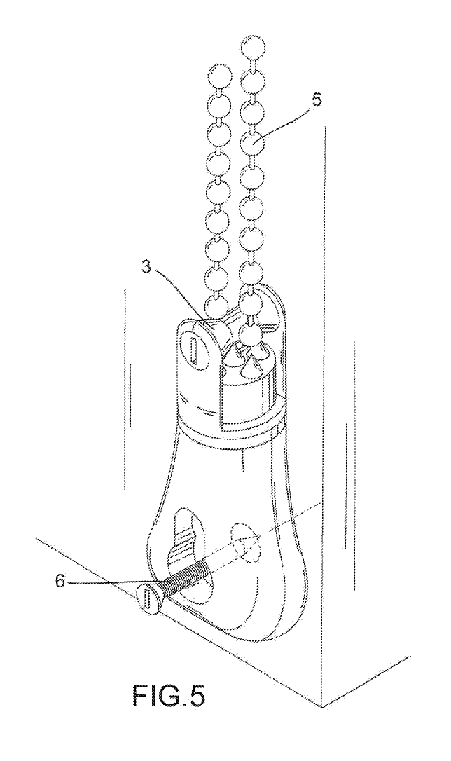

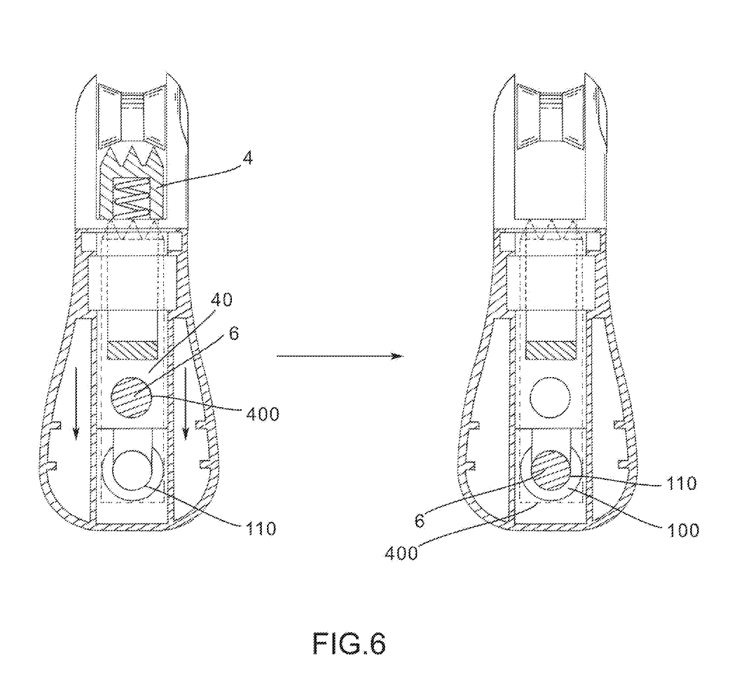

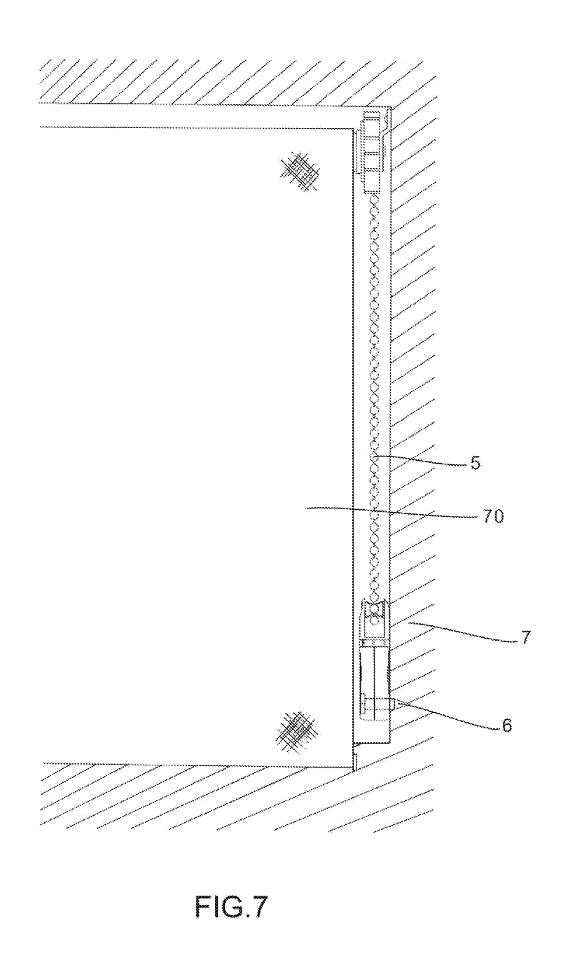

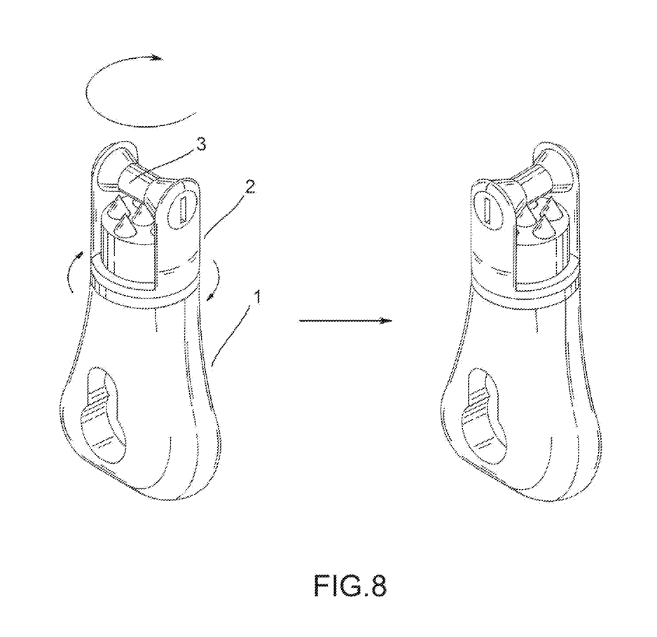

Please refer to FIG. 4. When it is necessary to fix the bead pull cord 5 of a roller curtain or a blind in a suspended state, the roller 3 is removed. Then the endless bead pull cord 5 is directly fitted onto the roller 3 from one side thereof. Then the locating screw 30 is passed through the roller 3 to locate the roller 3 between the two upward extending lugs 20, 21 of the movable support 2. At this time, the bead pull cord 5 is wound around the roller 3 and fixedly engaged with the fixing toothed section 4. Under such circumstance, the fixing support of the present invention is connected with the bead pull cord 5 (as shown in FIG. 5). Then, a fixing screw 6 is passed through the perforation 400 of the slide board 40 of the fixing toothed section 4 and pulled downward to move the fixing toothed section 4 downward along with the fixing screw 6. When the fixing screw 6 is moved to the circular hole 110 of the second casing 11 of the main support body 1, the fixing screw 6 is extended out of the second casing 11 and securely screwed into the wall face 7 of an inner window (as shown in FIGS. 6 and 7). At this time, the fixing toothed section 4 is slid downward to compress the elastic member 42 and disengaged from the roller 3. Under such circumstance, the bead pull cord 5 is released and free to operate for lifting or lowering the roller curtain 70. Moreover, the roller 3 can be 360-degree rotated. Therefore, in operation of the bead pull cord 5, the angle is not limited and the bead pull cord 5 can be smoothly operated in accordance with the suspending direction of the bead pull cord 5 (as shown in FIG. 8).

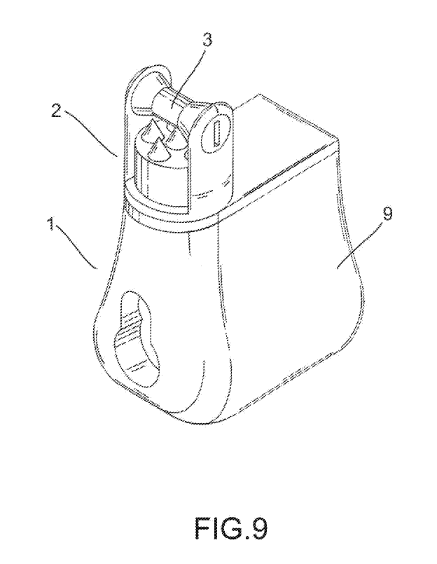

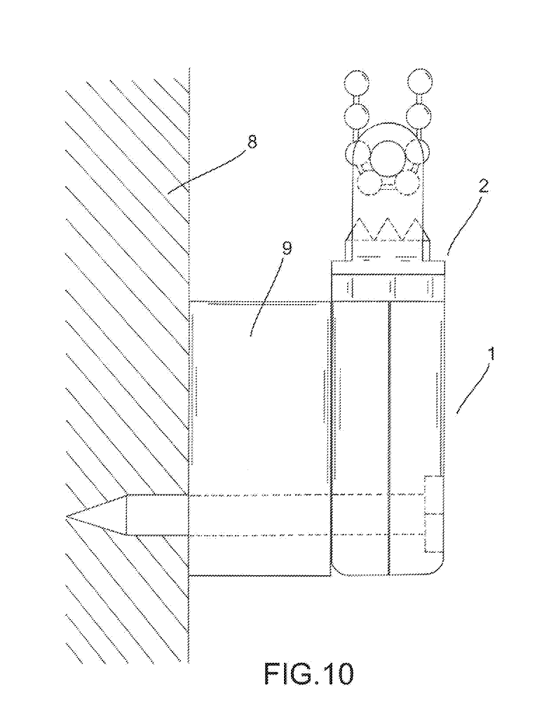

Please refer to FIG. 9. When it is desired to install the fixing support of the present invention on the wall face 8 of an outer window, the suspending angle of the bead pull cord 5 will turn from the wall face of the inner window to the wall face 8 of the outer window. In this case, a pad block 9 is first additionally disposed at the rear end of the main support body 1. After the assembling process of the bead pull cord 5 and the fixing support of the present invention is completed, the main support body 1 is directly affixed to the wall face 8 of the outer window. The roller 3 is freely rotatable along with the movable support 2 (as shown in FIG. 10) so that the bead pull cord 5 can be still smoothly pulled and operated to open/close the curtain.

The above embodiments are only used to illustrate the present invention, not intended to limit the scope thereof. Many modifications of the above embodiments can be made without departing from the spirit of the present invention.

What is claimed is:

1. A pull cord fixing support for inner and outer windows, comprising:
a main support body composed of a first casing and a second casing, which are mated and assembled with each other, the first casing being formed with a slot with a large-diameter end and a small-diameter end in communication with each other, the second casing being formed with a hole in alignment with the large-diameter end of the slot, whereby a fixing screw can be passed through the hole, an upper end of inner face of the second casing being formed with a receiving cavity, a lower end of the inner face of the second casing being formed with a slide channel;
a movable support having two lugs at upper end for mounting a roller between the two lugs, a bottom end of the movable support having a cylindrical body, which is rotatably received in the receiving cavity of the second casing; and
a fixing toothed section having a toothed seat at upper end, the fixing toothed section further having a slide board extending from a lower end of the fixing toothed section, the slide board being up and down slidably disposed in the slide channel of the second casing, a lower end of the slide board being formed with a perforation, an elastic member being received in the base seat to provide elastic force to make the fixing teeth of the fixing toothed section upward abut against a lower side of the roller.

2. The pull cord fixing support for inner and outer windows as claimed in claim 1, wherein the toothed seat includes a base seat and multiple fixing teeth disposed at an upper end of the base seat.

3. The pull cord fixing support for inner and outer windows as claimed in claim 2, wherein the fixing teeth are arranged at intervals.

4. The pull cord fixing support for inner and outer windows as claimed in claim 2, wherein the number of the fixing teeth is six.

5. The pull cord fixing support for inner and outer windows as claimed in claim 1, wherein the movable support is 360-degree rotatable.
